(19) United States
(12) Patent Application Publication
(10) Pub. No.: US 2012/0123717 A1
(43) Pub. Date: May 17, 2012

(54) ELECTRONIC DEVICE AND METHOD OF OPTIMIZING MEASUREMENT PATHS

(75) Inventors: CHIH-KUANG CHANG, Tu-Cheng (TW); XIN-YUAN WU, Shenzhen City (CN); GEN YANG, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 13/244,631

(22) Filed: Sep. 25, 2011

(30) Foreign Application Priority Data
Nov. 16, 2010 (CN) 201010545613.5

(51) Int. Cl. G06F 19/00

(52) U.S. Cl. 702/83

(57) ABSTRACT

A method of optimizing measurement paths computes a minimum bounding box for the measurement elements on a product, and computes a capturing range of a lens of a measurement machine. The method divides the minimum bounding box into M*N partitions according to the capturing range, and assigns a number to each of the M*N partitions. The method puts the number of a partition which exclusively encloses a measurement element into a first array, and puts a number set that includes the numbers of the partitions which all enclose a measurement element into a second array, and lists the numbers of the partitions in order according to the first array and the second array to generate a measurement path.

### BACKGROUND

1. Technical Field

Embodiments of the present disclosure relate to systems and methods of product measurement, and more particularly to an electronic device and a method of optimizing a measurement path for a measurement machine when measuring a product.

2. Description of Related Art

In the field of manufacturing, most products are measured by measurement machines. Usually, when measuring a product using a measurement machine, the measurement machine needs to move along a measurement path to take all measurements (e.g., measurement elements) of the product. The measurement elements include, for example, points, lines, planes, and circles.

In the past, the measurement path of the measurement machine when taking measurements of a product is determined by the sequence of creating the measurement elements. Referring to FIG. 1, the measurement elements on the product are created from S1 to S12, thus, the measurement path followed by the measurement machine is from the measurement element S1 to the measurement element S12. From FIG. 1, it can be seen that, the measurement path is arbitrary and disordered, which may result in an increased measurement time.

### BRIEF DESCRIPTION OF THE DRAWINGS

FIG. 1 is an example illustrating an original measurement path when measuring a product.

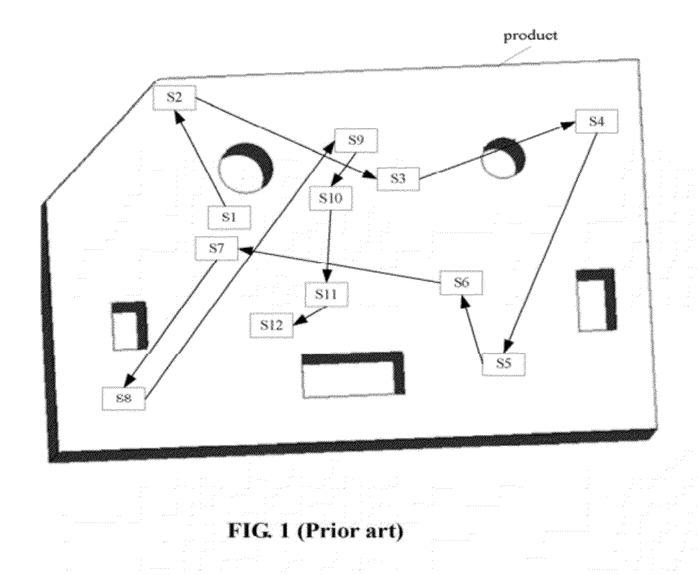

FIG. 2 is a block diagram of one embodiment of an electronic device including a measurement path optimization system.

FIG. 3 is a block diagram of one embodiment of function modules of the measurement path optimization system.

FIG. 4 is a flowchart of one embodiment of a method of optimizing measurement paths.

FIG. 5 is an example of a minimum bounding box with twelve measurement elements.

FIG. 6 illustrates the determination of an optimized measurement path of the twelve measurement elements in FIG. 5 using the method given in FIG. 4.

FIG. 7 illustrates a measurement path optimized for measuring the product in FIG. 1.

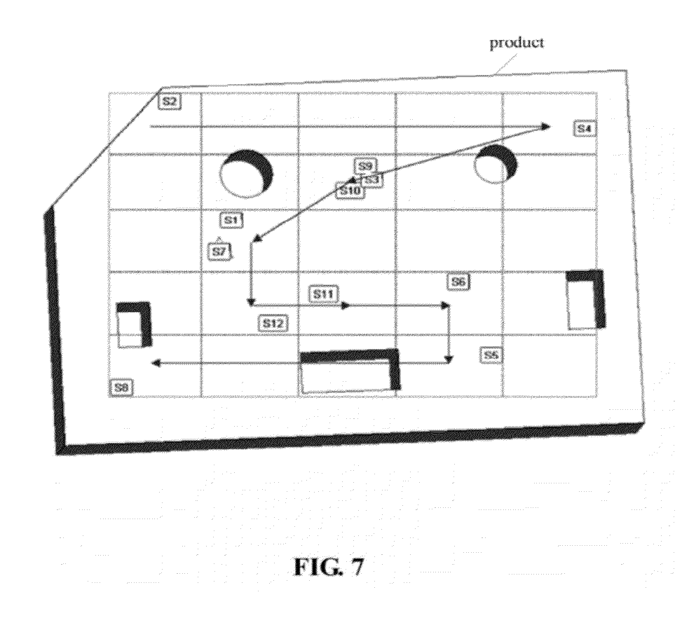

### DETAILED DESCRIPTION

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

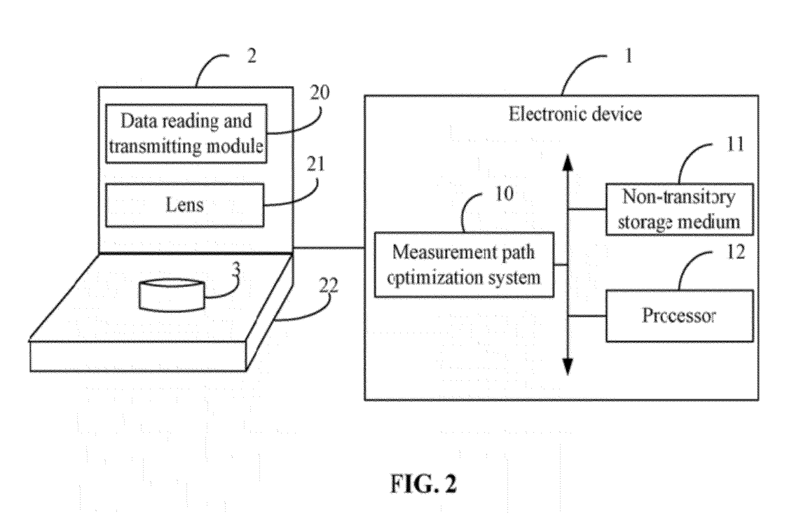

FIG. 2 is a block diagram of one embodiment of an electronic device 1 including a measurement path optimization system 10. In the embodiment, the electronic device 1 further includes a non-transitory storage medium (hereinafter, storage medium for short) 11, and at least one processor 12. Depending on the embodiment, the storage medium 11 may be a hard disk drive, a compact disc, a digital video disc, a tape drive or other suitable storage medium.

The electronic device 1 is electronically connected with a measurement machine 2. The measurement machine 2 includes a data reading and transmitting module 20, a lens 21, and a platform 22. Using the lens 21, the measurement machine 2 captures images of a product 3 placed on the platform 22. The data reading and transmitting module 20 reads information of the measurement elements created on the product 3 from the images, and transmits the information to the electronic device 1. In one embodiment, the information includes a quantity, positional coordinates, and feature values of the measurement elements. The measurement elements include points, lines, planes, and circles, for example. The positional coordinates of a measurement element are the coordinates of points that are used for creating the measurement element. For example, a line is created based on at least two points, thus, the positional coordinates of the line may include the coordinates of the at least two points. For another example, a circle is created based on at least three points, thus, the positional coordinates of the circle may include the coordinates of the at least three points. The feature value of a measurement element indicates whether the measurement element is a point, a line, a plane, or a circle. For example, feature value 1 may indicate that the measurement element is a point, feature value 2 may indicate that the measurement element is a line.

The measurement path optimization system 10 may be used to compute an optimized measurement path for the measurement machine 2 when measuring the product 3 according to the above-mentioned information regarding each measurement element on the product 3.

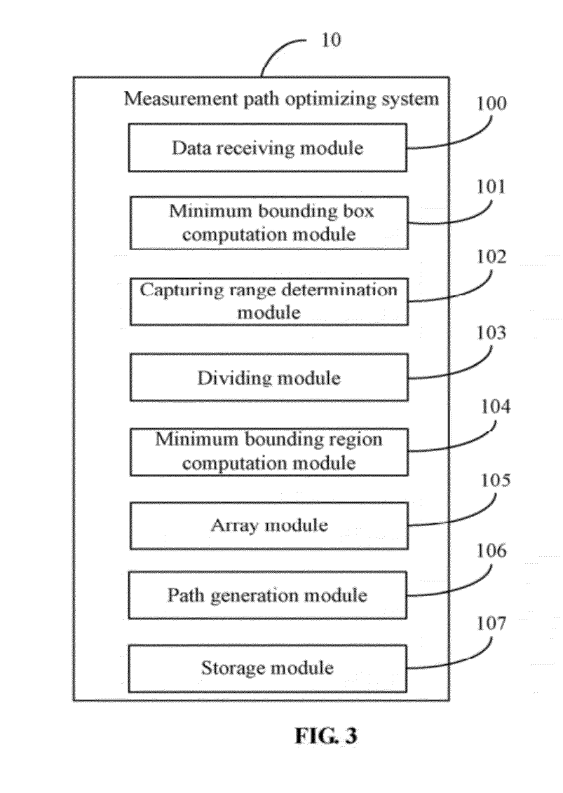

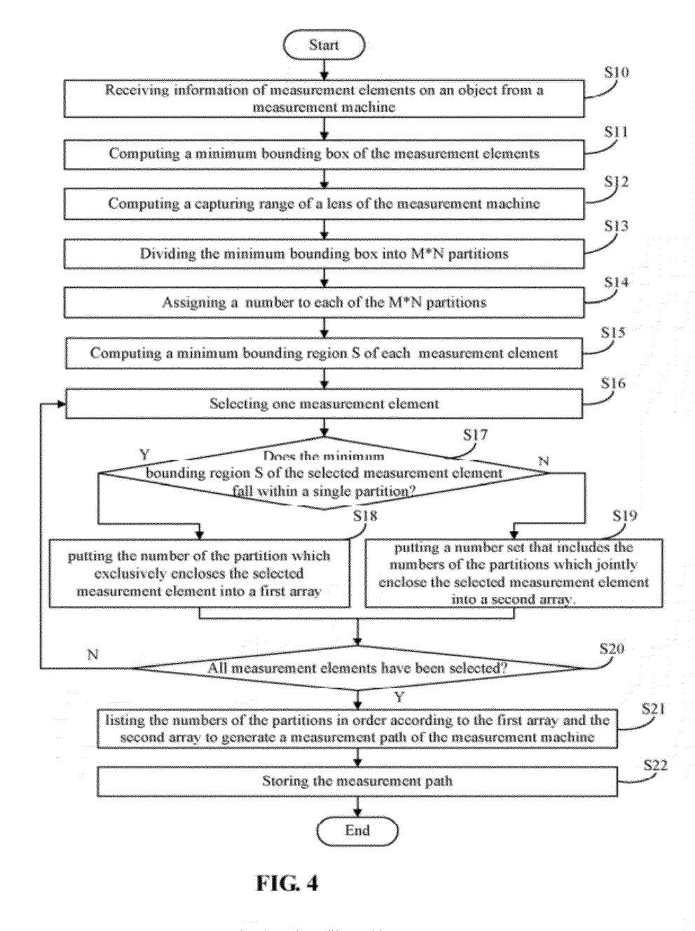

FIG. 3 is a block diagram of one embodiment of the measurement path optimization system 10. In one embodiment, the measurement path optimization system 10 may include one or more modules, for example, a data receiving module 100, a minimum bounding box computation module 101, a capturing range determination module 102, a dividing module 103, a minimum bounding region computation module 104, an array module 105, a path generation module 106, and a storage module 107. The one or more modules 100-107 may comprise computerized code in the form of one or more programs that are stored in the storage medium 11. The computerized code includes instructions that are executed by the at least one processor 12 to provide the functions mentioned below of the one or more modules 100-107 illustrated in FIG. 4.

FIG. 4 is a flowchart of one embodiment of a method of optimizing measurement paths using the electronic device 1 of the FIG. 2. Depending on the embodiment, additional blocks may be added, others removed, and the ordering of the blocks may be changed.

In block S10, the data receiving module 100 receives information of the measurement elements on the product 3 from the measurement machine 2. As mentioned above, the information includes a quantity, positional coordinates, and feature values of the measurement elements.

In block S11, the minimum bounding box computation module 101 computes a minimum bounding box of the measurement elements on the product 3 according to the positional coordinates. The minimum bounding box is the smallest box that can enclose all of the measurement elements. In one embodiment, the method of computing the minimum bounding box is given as follows: the minimum bounding box computation module 101 finds the maximum X-axis coordinate “Xmax”, the maximum Y-axis coordinate “Ymax”, the minimum X-axis coordinate “Xmin”, and the minimum Y-axis coordinate “Ymin” from the positional coordinates of the measurement elements, then determines the four points which respectively have the coordinates of (Xmax, Ymax), (Xmax, Ymin), (Xmin, Xmax), and (Xmin, Ymin), and finally locates the minimum bounding box according to those four points (i.e. Xmax, Ymax), (Xmax, Ymin), (Xmin, Xmax), and (Xmin, Ymin).

In block S12, the capturing range determination module 102 computes a capturing range of the lens 21 according to a magnification of the lens 21. The capturing range and the magnification have an internal relationship. For example, if the magnification of the lens 21 is 2:1, the capturing range may be 10 cm², and if the magnification is 4:1, the capturing range may be 20 cm², and if the magnification of the lens 21 is 8:1, the capturing range may be 40 cm².

In block S13, the dividing module 103 divides the minimum bounding box into M*N partitions according to the capturing range of the lens 21. In one embodiment, if the capturing range has a length L and a width W, then, M=(Xmax−Xmin)/L, N=(Ymax−Ymin)/W; or M=(Xmax−Xmin)/W, N=(Ymax−Ymin)/L.

In block S14, the dividing module 103 assigns a number to each of the M*N partitions.

In block S15, the minimum bounding region computation module 104 computes the minimum bounding region S of each measurement element according to the positional coordinates of the measurement element. In one embodiment, the method of computing the minimum bounding region S is similar to the method of computing the minimum bounding box given above.

In block S16, the array module 105 selects one measurement element. In one embodiment, this selection is random.

In block S17, the array module 105 determines if the minimum bounding region S of the selected measurement element falls within a single partition.

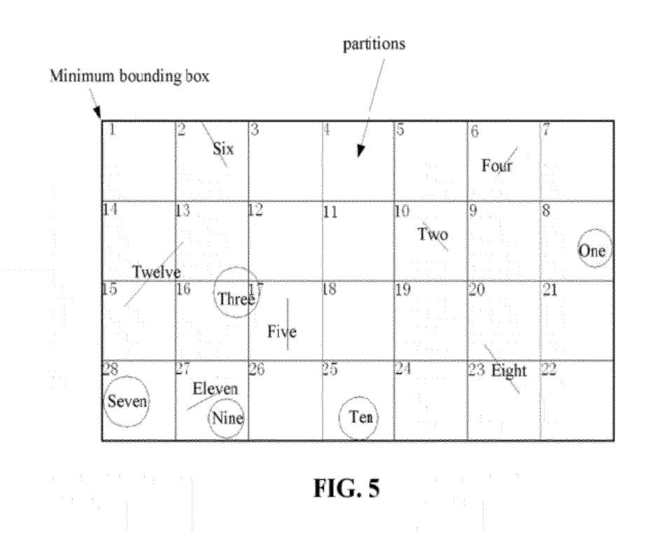

FIG. 5 is an example of a minimum bounding box with twelve measurement elements. In the example given in FIG. 5, the minimum bounding box is divided into twenty-eight partitions, including four columns and seven rows. Measurement elements labeled as one, three, seven, nine, and ten are circles, measurement elements labeled as two, four, five, six, eight, eleven, and twelve are lines. As seen in FIG. 5, the minimum bounding region S of each of the measurement elements labeled as one, two, four, five, six, seven, nine, ten and eleven is enclosed within a single partition, the minimum bounding region S of the measurement element labeled as three is enclosed by four partitions, including partitions numbered as 12, 13, 16, and 17, the minimum bounding region S of the measurement element labeled as eight is enclosed by two partitions, including partitions numbered as 20 and 23, and the minimum bounding region S of the measurement element twelve is enclosed by three partitions, including partitions numbered as 13, 14, and 15.

In block S18, the array module 105 puts the number of the partition which exclusively encloses the selected measurement element into a first array. In block S19, the array module 105 puts a number set that includes the numbers of all the partitions which enclose the selected measurement element into a second array. In the example in FIG. 5, the first array includes the numbers 2, 6, 8, 10, 17, 25, 27, and 28, and the second array includes the number sets (12, 13, 16, 17), (20, 23), and (13, 14, 15).

In block S20, the array module 105 determines if all the measurement elements have been selected according to the received quantity. Block S16 is repeated if any measurement elements has not been selected. Block S21 is implemented if all the measurement elements have been selected.

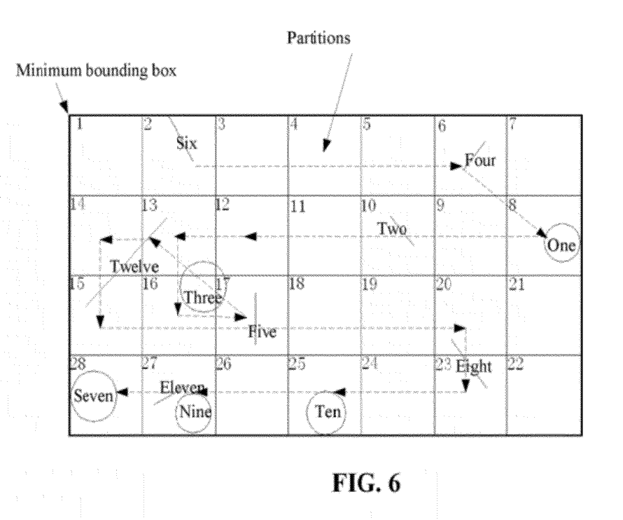

In block S21, the path generation module 106 lists the numbers of the partitions in order according to the first array and the second array to generate a measurement path of the measurement machine 2. In detail, the path generation module 106 selects numbers from the first array and the second array in ascending order. If the number is from the first array, the path generation module 106 inserts the number into the measurement path, and if the number is from the second array, the path generation module 106 inserts a number set which includes that number into the measurement path. If a number or a number set has been inserted into the measurement path, the path generation module 106 does not select the number or numbers in the number set any more. In the example of the first array including numbers of 2, 6, 8, 10, 17, 25, 27, and 28, and the second array including numbers of (12, 13, 16, 17), (20, 23), (13, 14, 15), the measurement path may follow the order of 2, 6, 8, 10, (12, 13, 16, 17), (13, 14, 15), (20, 23), 25, 27, and 28, as in the measurement path (the dashed arrow) shown in FIG. 6.

In block S22, the storage module 107 stores the measurement path into the storage medium 11, and by this method, the measurements of the product are taken more quickly and efficiently.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A method of optimizing measurement paths being performed by execution of computerized code by a processor of an electronic device, the method comprising:
computing a minimum bounding box of measurement elements of a product;
computing a capturing range of a lens of a measurement machine according to a magnification of the lens;
dividing the minimum bounding box into M*N partitions according to the capturing range, and assigning a number to each of the M*N partitions;
computing a minimum bounding region S of each of the measurement elements;
selecting a measurement element one by one, and determining if the minimum bounding region S of the selected measurement element falls within a single partition;
putting the number of the partition which exclusively encloses the selected measurement element into a first array, and putting a number set that includes the numbers of the partitions which jointly enclose the selected measurement element into a second array;
listing the numbers of the partitions in order according to the first array and the second array to generate a measurement path of the measurement machine; and
storing the measurement path into a storage medium.

2. The method according to claim 1, wherein the measurement elements comprise points, lines, planes, and circles.

3. The method according to claim 1, before computing a minimum bounding box further comprising:
receiving information of the measurement elements from the measurement machine.

4. The method according to claim 3, wherein the information comprises a quantity, positional coordinates, and feature values of the measurement elements.

5. The method according to claim 4, wherein the minimum bounding box is computed by: acquiring the positional coordinates of the measurement elements, finding a maximum X-axis coordinate “Xmax”, a maximum Y-axis coordinate “Ymax”, a minimum X-axis coordinate “Xmin”, and a minimum Y-axis coordinate “Ymin” from the positional coordinates of the measurement elements, determining four points which respectively has coordinates of (Xmax, Ymax), (Xmax, Ymin), (Xmin, Xmax), and (Xmin, Ymin), and locating the minimum bounding box according to the four points (Xmax, Ymax), (Xmax, Ymin), (Xmin, Xmax), and (Xmin, Ymin).

6. The method according to claim 1, wherein the numbers of the partitions is listed by: selecting a number from the first array and the second array according to an ascending order; inserting the number into the measurement path if the number is from the first array, or inserting a number set which includes the number into the measurement path if the number is from the second array.

7. An electronic device, comprising:
a non-transitory storage medium;
at least one processor; and
one or more modules that are stored in the non-transitory storage medium; and are executed by the at least one processor, the one or more modules comprising instructions:
to compute a minimum bounding box of measurement elements on a product;
to compute a capturing range of a lens of a measurement machine according to a magnification of the lens;
to divide the minimum bounding box into M*N partitions according to the capturing range, and assign a number to each of the M*N partitions;
to compute a minimum bounding region S of each of the measurement elements;
to select a measurement element one by one, and determine if the minimum bounding region S of the selected measurement element falls within a single partition;
to put the number of the partition which exclusively encloses the selected measurement element into a first array, and put a number set that includes the numbers of the partitions which jointly enclose the selected measurement element into a second array;
to list the numbers of the partitions in order according to the first array and the second array to generate a measurement path of the measurement machine; and
to store the measurement path into the storage medium.

8. The electronic device according to claim 7, wherein the measurement elements comprise points, lines, planes, and circles.

9. The electronic device according to claim 7, before computing a minimum bounding box further comprising:
receiving information of the measurement elements on the product from the measurement machine.

10. The electronic device according to claim 9, wherein the information comprises a quantity, positional coordinates, and feature values of the measurement elements.

11. The electronic device according to claim 10, wherein the minimum bounding box is computed by: acquiring the positional coordinates of the measurement elements, finding a maximum X-axis coordinate “Xmax”, a maximum Y-axis coordinate “Ymax”, a minimum X-axis coordinate “Xmin”, and a minimum Y-axis coordinate “Ymin” from the positional coordinates of the measurement elements, determining four points which respectively has coordinates of (Xmax, Ymax), (Xmax, Ymin), (Xmin, Xmax), and (Xmin, Ymin), and locating the minimum bounding box according to the four points (Xmax, Ymax), (Xmax, Ymin), (Xmin, Xmax), and(Xmin, Ymin).

12. The electronic device according to claim 7, wherein the numbers of the partitions is listed by: selecting a number from the first array and the second array according to an ascending order; inserting the number into the measurement path if the number is from the first array, or inserting a number set which includes the number into the measurement path if the number is from the second array.

13. A non-transitory storage medium having stored thereon instructions that, when executed by a processor of an electronic device, causes the processor to perform a method of optimizing measurement paths, wherein the method comprises:
computing a minimum bounding box of measurement elements on a product;
computing a capturing range of a lens of a measurement machine according to a magnification of the lens;
dividing the minimum bounding box into M*N partitions according to the capturing range, and assigning a number to each of the M*N partitions;
computing a minimum bounding region S of each of the measurement elements;
selecting a measurement element one by one, and determining if the minimum bounding region S of the selected measurement element falls within a single partition;
putting the number of the partition which exclusively encloses the selected measurement element into a first array, and putting a number set that includes the numbers of the partitions which jointly enclose the selected measurement element into a second array; and
listing the numbers of the partitions in order according to the first array and the second array to generate a measurement path of the measurement machine.

14. The non-transitory storage medium according to claim 13, wherein the measurement elements comprise points, lines, planes, and circles.

15. The non-transitory storage medium according to claim 13, before computing a minimum bounding box further comprising:
receiving information of the measurement elements on the product from the measurement machine.

16. The non-transitory storage medium according to claim 15, wherein the information comprises a quantity, positional coordinates, and feature values of the measurement elements.

17. The non-transitory storage medium according to claim 16, wherein the minimum bounding box is computed by: acquiring the positional coordinates of the measurement elements, finding a maximum X-axis coordinate “Xmax”, a maximum Y-axis coordinate “Ymax”, a minimum X-axis coordinate “Xmin”, and a minimum Y-axis coordinate “Ymin” from the positional coordinates of the measurement elements, determining four points which respectively has coordinates of (Xmax, Ymax), (Xmax, Ymin), (Xmin, Xmax), and (Xmin, Ymin), and locating the minimum bounding box according to the four points (Xmax, Ymax), (Xmax, Ymin), (Xmin, Xmax), and (Xmin, Ymin).

18. The non-transitory storage medium according to claim 13, wherein the numbers of the partitions is listed by: selecting a number from the first array and the second array according to an ascending order; inserting the number into the measurement path if the number is from the first array, or inserting a number set which includes the number into the measurement path if the number is from the second array.
